(19) United States
(12) Patent Application Publication
(10) Pub. No.: US 2025/0317654 A1
(43) Pub. Date: Oct. 9, 2025

(54) IMAGE CORRECTION METHOD AND APPARATUS, ELECTRONIC DEVICE, AND STORAGE MEDIUM

(71) Applicant: Beijing Bytedance Network Technology Co., Ltd., Beijing (CN)

(72) Inventors: Yuzhong CHEN, Beijing (CN); Shaohui JIAO, Beijing (CN); Yaoyao WU, Beijing (CN)

(21) Appl. No.: 18/865,668

(22) PCT Filed: Apr. 19, 2023
(86) PCT No.: PCT/CN2023/089112

§ 371 Date: Nov. 13, 2024

(30) Foreign Application Priority Data
May 13, 2022 (CN) 202210523446.7

(51) Int. Cl. H04N 23/698; G06T 5/80; G06T 7/55; G06T 7/80

(52) U.S. Cl. CPC H04N 23/698; G06T 5/80; G06T 7/55; G06T 7/80; G06T 2207/20068

(57) ABSTRACT

Disclosed in embodiments of the present disclosure are an image correction method and apparatus, an electronic device, and a storage medium. The method may include: for each of a plurality of photographing devices, obtaining a target image photographed by the photographing device; and correcting the target image on the basis of a correction parameter corresponding to the photographing device, wherein when at least two axis points on a rotating axis including a virtual center are projected onto the target image to obtain a projection axis, a projection axis on each corrected target image is consistent, and the virtual center is located on virtual planes corresponding to the plurality of photographing devices and corresponds to physical optical centers of the plurality of photographing devices.

The present disclosure claims priority of the Chinese patent application No. 202210523446.7, filed with the China Patent Office on May 13, 2022, the entire contents of which are incorporated into the present disclosure by reference.

### TECHNICAL FIELD

Embodiments of the present disclosure relate to the technical field of image processing, for example, to an image correction method, an apparatus, an electronic device, and a storage medium.

### BACKGROUND

Free perspective video is a popular form of video nowadays, and it is endowed with a fixed two-dimensional (2D) video viewing experience of “changing scenery in steps” by providing users with the function of interactive selection of viewing angles, thus the strong three-dimensional impact is brought to the users.

### SUMMARY

Embodiments of the present disclosure provide an image correction method, an apparatus, an electronic device, and a storage medium, so as to eliminate an image jittering phenomenon caused by the change of adjacent perspectives.

In a first aspect, an embodiment of the present disclosure provides an image correction method, which may include:
for each shooting device in a plurality of shooting devices, acquiring a target image shot by the shooting device; and
based on a correction parameter corresponding to the shooting device, correcting the target image;
in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

In a second aspect, an embodiment of the present disclosure further provides an image correction apparatus, which may include:
a target image acquisition module, configured to, for each shooting device in a plurality of shooting devices, acquire a target image shot by the shooting device; and
a target image correction module, configured to, based on a correction parameter corresponding to the shooting device, correct the target image;
in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

In a third aspect, an embodiment of the present disclosure further provides an electronic device, which may include:
one or more processors; and
a memory, configured to store one or more programs,
in the case that the one or more programs are executed by the one or more processors, the image correction method provided in any embodiments of the present disclosure is implemented by the one or more processors.

In a fourth aspect, an embodiment of the present disclosure further provides a computer-readable storage medium, in which a computer program is stored, and the image correction method provided in any embodiments of the present disclosure may be implemented in the case that the computer program is executed by a processor.

### BRIEF DESCRIPTION OF DRAWINGS

Throughout the drawings, the same or similar reference numbers refer to the same or similar elements. It is understood that the drawings are schematic and that components and elements are not necessarily drawn to scale.

FIG. 1 is a flow diagram of an image correction method in an embodiment of the present disclosure;

FIG. 2 is a flow diagram of another image correction method in an embodiment of the present disclosure;

FIG. 3 is a schematic diagram of an example of another image correction method in an embodiment of the present disclosure;

FIG. 4 is a flow diagram of another image correction method in an embodiment of the present disclosure;

FIG. 5 is a schematic diagram of an example of another image correction method in an embodiment of the present disclosure;

FIG. 6 is a structure block diagram of an image correction apparatus in an embodiment of the present disclosure; and

FIG. 7 is a structure schematic diagram of an electronic device in an embodiment of the present disclosure.

### DETAILED DESCRIPTION

The production process of the free perspective video requires a multi-angle and multi-camera shooting environment, and in view of the smoothness and continuity of images (such as video frames) when the perspective is rotated, the higher requirements for camera deployment (such as a camera placement position and a pitching orientation) are put forward. At present, the above requirements are mainly met by manual deployment of cameras.

However, the manual deployment is time-consuming, labor-intensive, and has relatively low accuracy (that is, it may not truly meet the above requirements), which causes that the images may produce an apparent jittering phenomenon when the adjacent perspectives change, such as vertical parallax, horizontal parallax, and image scaling, thereby affecting the users' video viewing experience.

Considering the above situation, the embodiments of the present disclosure provide an image correction method, an apparatus, an electronic device, and a storage medium.

Embodiments of the present disclosure are described below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, that is, “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged among multiple apparatuses in the embodiment of the present disclosure are only configured for illustrative purposes, and are not configured to limit the scope of these messages or information.

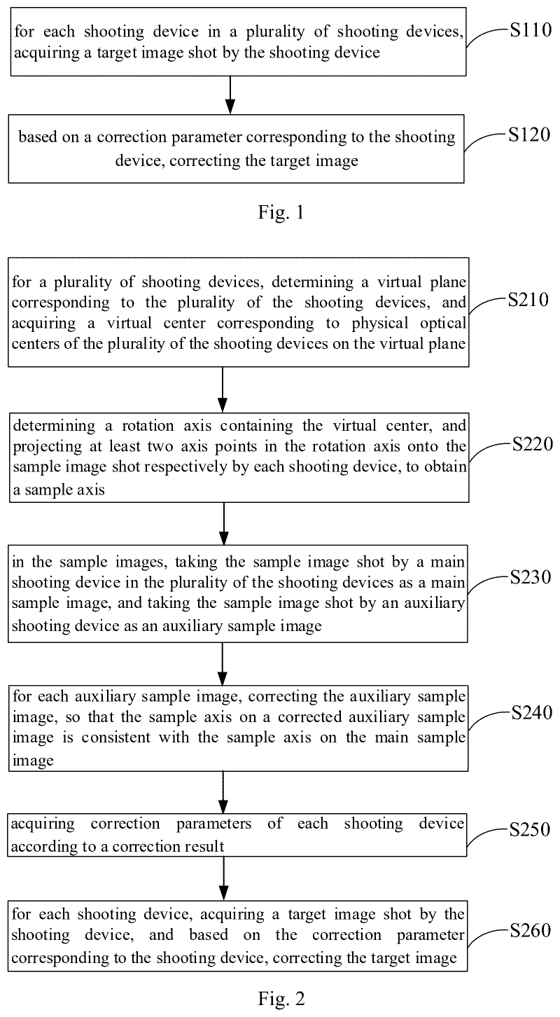

FIG. 1 is a flow diagram of an image correction method provided in an embodiment of the present disclosure. This embodiment can perform image correction, and can correct target images shot by a plurality of shooting devices. This method may be performed by an image correction apparatus provided in an embodiment of the present disclosure, the apparatus may be implemented in the form of software and/or hardware, the apparatus may be integrated on an electronic device, and the electronic device may be various terminal devices or servers.

Referring to FIG. 1, the method in the embodiment of the present disclosure includes the following steps:
S110, for each shooting device in a plurality of shooting devices, acquiring a target image shot by the shooting device.

The plurality of the shooting devices may be a plurality of electronic devices with shooting functions, such as a camera, a vidicon or a webcam. In practical applications, for example, these shooting devices may be configured for free perspective shooting or optical field shooting or the like, which is not specifically limited here; for another example, these shooting devices may be deployed in a circular shape around a shooting subject, so as to synchronously collect videos or images of the shooting subject, thereby bringing a smooth spatial video or image viewing experience to the users. The target image may be an image shot (that is, collected) by any one shooting device in the plurality of the shooting devices or a certain video frame (that is, a video picture) in a video, and the video may be a recorded video or a live video or the like, which is not specifically limited here.
S120, based on a correction parameter corresponding to the shooting device, correcting the target image. In the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

Each shooting device corresponds to its own correction parameter, which is configured to correct the target image shot by the corresponding shooting device, and for example, may be a parameter for geometric correction or affine transformation correction. In practical applications, for example, the correction parameter may be represented in various ways, such as a correction matrix, a correction vector, a correction tensor, or a correction image. For each shooting device, based on the correction parameter corresponding to the shooting device, the target image shot by the shooting device is corrected. On this basis, for example, in the case that the target image is a video frame, the corrected video frame may be stored offline or played in real-time.

It should be noted that in the case that the plurality of the shooting devices is set up manually, they are usually expected to be set up on the same plane (that is, the same height), however, they are difficult to be truly set up on the same plane, and the virtual plane corresponding to the plurality of the shooting devices may be understood as this same plane, that is, the plane on which each shooting device meeting set up expectations is located. The virtual center may be a center corresponding to the physical optical centers of the plurality of the shooting devices on the virtual plane, that is, the center in which optical axes of the shooting devices converge in the case that their set up positions meet the expectations, at this time, each physical optical center is located on a standard circle. On this basis, for at least two axis points in the rotation axis containing the virtual center, in the case that the at least two axis points are projected onto the target image to obtain the projection axis, the projection axes on corrected target images are consistent, that is, the corrected target images correspond to the same rotation axis, in other words, spatial points on the target images are all converted from respective shooting device coordinate systems to a fixed axis coordinate system (that is, the target images with different axis points are already corrected to the target images with the same axis point), so that the corrected target images no longer have a jittering phenomenon due to the change of perspectives. It should be emphasized that there may not be a projection axis on the target image before and after correction, and the above text only shows a correction effect by projecting the projection axis onto the target image.

In the embodiments of the present disclosure, for each shooting device in the plurality of the shooting devices, the target image shot by the shooting device is corrected by the correction parameter corresponding to the shooting device. In the above embodiments, for the virtual center corresponding to the physical optical centers of the plurality of the shooting devices on the virtual plane corresponding to the plurality of the shooting devices, and in the case that at least two axis points in the rotation axis containing the virtual center are projected onto the target image to obtain the projection axis, the projection axes on the corrected target images are consistent, which indicates that the corrected target images correspond to the same rotation axis, that is, the spatial points on them are all converted from the respective shooting device coordinate systems to the fixed axis coordinate system. Therefore, the corrected target images no longer have the jittering phenomenon due to the change of perspectives, thereby eliminating the image jittering phenomenon caused by the change of the adjacent perspectives, and because the image may be synchronously corrected in the normal shooting process, requirements for setting up accuracy of the plurality of the shooting devices are reduced.

FIG. 2 is a flow diagram of another image correction method provided in an embodiment of the present disclosure. This embodiment is adjusted based on the above embodiments. In this embodiment, the correction parameter is predetermined by the following steps: determining the virtual plane, and acquiring the virtual center on the virtual plane; determining the rotation axis containing the virtual center, and projecting the at least two axis points in the rotation axis onto a sample image shot respectively by each shooting device, to obtain a sample axis; in the sample images, taking the sample image shot by a main shooting device in the plurality of the shooting devices as a main sample image, and taking the sample image shot by an auxiliary shooting device as an auxiliary sample image; for each auxiliary sample image, correcting the auxiliary sample image, so that the sample axis on a corrected auxiliary sample image is consistent with the sample axis on the main sample image; and acquiring the correction parameter of each of the shooting device according to a correction result. The explanation of terms that are the same or correspond to the above embodiments is not repeatedly described here.

Correspondingly, as shown in FIG. 2, the method in this embodiment may include the following steps:
S210, for a plurality of shooting devices, determining a virtual plane corresponding to the plurality of the shooting devices, and acquiring a virtual center corresponding to physical optical centers of the plurality of the shooting devices on the virtual plane.

The plurality of the shooting devices corresponds to the same virtual plane, and the plurality of the physical optical centers corresponds to the same virtual center, the virtual plane and the virtual center have already been explained in the above text, which will not be repeatedly described here.
S220, determining a rotation axis containing the virtual center, and projecting at least two axis points in the rotation axis onto the sample image shot respectively by each shooting device, to obtain a sample axis.

One axis point in the rotation axis is the virtual center, and the rotation axis may be an axis perpendicular to the virtual plane or an axis inclined at a certain angle to the virtual plane, which is not specifically limited here. The at least two axis points in the rotation axis may be manually selected or automatically determined; and the at least two axis points may include the virtual center, and may also not include the virtual center, which is not specifically limited here. These axis points are projected onto the sample image shot respectively by each shooting device, that is, each sample image contains these axis points projected, these axis points on any one sample image constitute the respective projection axis, and the projection axis may be represented by a projection straight line, a projection ray, or a projection line segment or the like. These sample images may be images shot synchronously by these shooting devices, such as the same video frame in a shooting video; and they may be images shot non-synchronously, which is not specifically limited here.

It should be noted that the essence of the sample image and the target image are both images, this is only for different naming in order to distinguish between the images shot in the correction parameter determination process and the images shot in the correction parameter application process, and is not a specific limitation on their essential meanings.
S230, in the sample images, taking the sample image shot by a main shooting device in the plurality of the shooting devices as a main sample image, and taking the sample image shot by an auxiliary shooting device as an auxiliary sample image.

The main shooting device is determined from the plurality of the shooting devices, and the sample image shot by the main shooting device is taken as the main sample image; and on this basis, the other shooting devices except for the main shooting device are taken as the auxiliary shooting devices respectively, and the sample image shot by the auxiliary shooting device is taken as the auxiliary sample image. In practical applications, for example, the number of the main shooting device may be one, and in order to combine with subsequent steps, the auxiliary sample images shot by the other auxiliary shooting devices are all corrected by taking the main sample image as a standard, thereby guaranteeing the consistency of the sample axes on each sample image.
S240, for each auxiliary sample image, correcting the auxiliary sample image, so that the sample axis on a corrected auxiliary sample image is consistent with the sample axis on the main sample image.
S250, acquiring correction parameters of each shooting device according to a correction result.

For each auxiliary sample image, in the case that it is corrected so that the sample axis on it is consistent with the sample axis on the main sample image, the correction parameter may be acquired according to the correction process, that is, the correction parameter corresponding to the auxiliary shooting device that shoots the sample image, thereby acquiring the correction parameter of each auxiliary shooting device. In addition, in the case that no correction is made to the main sample image before comparing with the main sample image, the correction parameter corresponding to the main shooting device may be understood as a parameter that may not cause distortion to the main sample image; otherwise, the corresponding correction parameter may be acquired according to the correction process of the main sample image.
S260, for each shooting device, acquiring a target image shot by the shooting device, and based on the correction parameter corresponding to the shooting device, correcting the target image.

In the embodiments of the present disclosure, at least two axis points in the rotation axis containing the virtual center are projected onto the sample image shot respectively by each shooting device, to obtain the sample axis; and, for the auxiliary sample image shot by each auxiliary shooting device in the plurality of the shooting devices in the sample images, the auxiliary sample image is corrected, so that the sample axis on the corrected auxiliary sample image is consistent with the sample axis on the main sample image shot by the main shooting device in the plurality of the shooting devices in the sample images, thereby acquiring the correction parameter of each shooting device according to the correction result, that is, by a mode of geometric projection operation, the correction parameters of each shooting device is acquired.

In an embodiment, based on the above embodiments, the above image correction method may further include: determining a pose parameter of each shooting device respectively; and on this basis, the step of determining the virtual plane, and acquiring the virtual center on the virtual plane may include: fitting to obtain a plane equation according to an optical center position of each optical center, and the virtual plane is acquired based on the plane equation; and for each shooting device, according to the plane equation and the pose parameter of the shooting device, projecting the optical center position corresponding to the shooting device onto the virtual plane, to obtain a projection position, after acquiring each projection position, fitting each projection position to obtain a virtual position, and acquiring the virtual center based on the virtual position.

The pose parameter of each shooting device is calibrated respectively. On this basis, the plane equation is acquired by fitting the optical center positions of the physical optical centers, and then the virtual plane is acquired based on the plane equation. In practical applications, for example, a plane coefficient may be calculated by using a least squares algorithm, and then the plane equation is acquired; for another example, the above optical center position may be represented by an optical center coordinate. For each shooting device, according to the plane equation and the pose parameter of the shooting device, the corresponding optical center position may be projected onto the virtual plane, to obtain the projection position, and after the projection positions of each of the optical center positions are acquired, the virtual position may be acquired by fitting these projection positions, such as fitting based on the least squares algorithm, and then the virtual center is acquired based on the virtual position. From this, it may be seen that the pose parameter is one of the important reference factors in the process of determining the correction parameter, and it guarantees the accuracy of determining the correction parameter.

In practical applications, for example, the pose parameter may be applied not only in optical center position projection, but also in axis point projection. For example, the step of projecting the at least two axis points in the rotation axis onto the sample image shot respectively by each shooting device may include: for each shooting device, based on the pose parameter of the shooting device, the at least two axis points in the rotation axis are projected onto the sample image shot by the shooting device.

On this basis, for example, the step of determining the pose parameter of each shooting device respectively may include: acquiring a sample image sequence shot by each shooting device respectively, and determining a feature matching relationship between sample image sequences; and acquiring the pose parameter of each shooting device respectively according to the feature matching relationship. That is, by acquiring multi-perspective videos collected and calculating the feature matching relationship between the multi-perspective videos, the pose parameter (that is, a calibration result) of each shooting device may be acquired, in practical applications, for example, the pose parameter may be represented by an external parameter (such as a rotation matrix and a translation matrix). It should be noted that the above calibration process is a self-calibration process, and in the calibration process, calibration may be completed by a recorded video without a calibration board, therefor, the calibration time is greatly reduced, and the calibration efficiency is improved.

In another example, based on the above embodiment, the step of determining the rotation axis containing the virtual center may include: acquiring a plane equation of the virtual plane, and normalizing the plane equation, to obtain a plane normal vector of the virtual plane; and taking an axis in which the plane normal vector containing the virtual center is located as the rotation axis. After the plane equation is normalized, the plane normal vector of the virtual plane may be acquired. Because the virtual plane contains at least one plane normal vector, the plane normal vector passing through the virtual center in the at least one plane normal vector can be taken as the rotation axis, thus the rotation axis perpendicular to the virtual plane is acquired. In practical applications, for example, the virtual plane is usually parallel to the ground, and the shooting subject usually stands on the ground (that is, perpendicular to the ground), therefore, in the case that the rotation axis is perpendicular to the virtual plane (that is, the ground), the corrected sample image corresponding to the rotation axis is more in line with the user's visual perception, and the user's experience is improved.

In another example, based on the above embodiments, the sample axis is represented by a sample line segment, and the step of correcting the auxiliary sample image, so that a sample axis on a corrected auxiliary sample image is consistent with the sample axis on the main sample image, may include: performing a correction operation on the auxiliary sample image, so that the sample line segment on the corrected auxiliary sample image and the sample line segment on the main sample image are parallel to each other and with a same length, and a relative position of the sample line segment on the corrected auxiliary sample image is the same as the relative position of the sample line segment on the main sample image, herein the correction operation includes a rotation operation, a scaling operation, and a translation operation. The rotation operation may make the sample line segment on the corrected auxiliary sample image parallel to the sample line segment on the main sample image, the scaling operation may make the sample line segment on the corrected auxiliary sample image have the same length as the sample line segment on the main sample image, and the translation operation may make the relative position of the sample line segment on the corrected auxiliary sample image same as the relative position of the sample line segment on the main sample image, thereby guaranteeing the consistency between the sample line segment on the corrected auxiliary sample image and the sample line segment on the main sample image, that is, the consistency of the axis points on both. It should be noted that there is no specific requirement for the execution sequence of the rotation operation, the scaling operation, and the translation operation, because they may all be attributed to the correction parameter. Exemplarily, the correction parameter represented by the correction matrix is taken as an example, the rotation matrix corresponding to the rotation operation, the scaling matrix corresponding to the scaling operation, and the translation matrix corresponding to the translation operation may be combined, thereby obtaining the correction matrix.

In another example, based on the above embodiments, before the auxiliary sample image is corrected, the above image correction method may further include: rotating the main sample image, so that the sample axis on a rotated main sample image is parallel to a target axis of the main sample image; updating the main sample image according to a rotation result, and acquiring the correction parameter of the main shooting device; and the step of acquiring the correction parameter of each shooting device according to the correction result may include: acquiring the correction parameter of the auxiliary shooting device according to the correction result. The target axis may be a horizontal axis or a vertical axis of the sample image, in practical applications, for example, it may be the vertical axis, in this way, in the case that the shooting subject is horizontally shot, the shooting subject stands vertically on the ground in the rotated main sample image, which is more in line with the user's visual perception. Furthermore, the main sample image is updated according to the rotation result, so that the remaining auxiliary sample images may be corrected by taking the rotated main sample image as a standard, and the correction parameter of the auxiliary shooting device may be acquired according to the correction result; at the same time, the correction parameter of the main shooting device may also be acquired according to the rotation result.

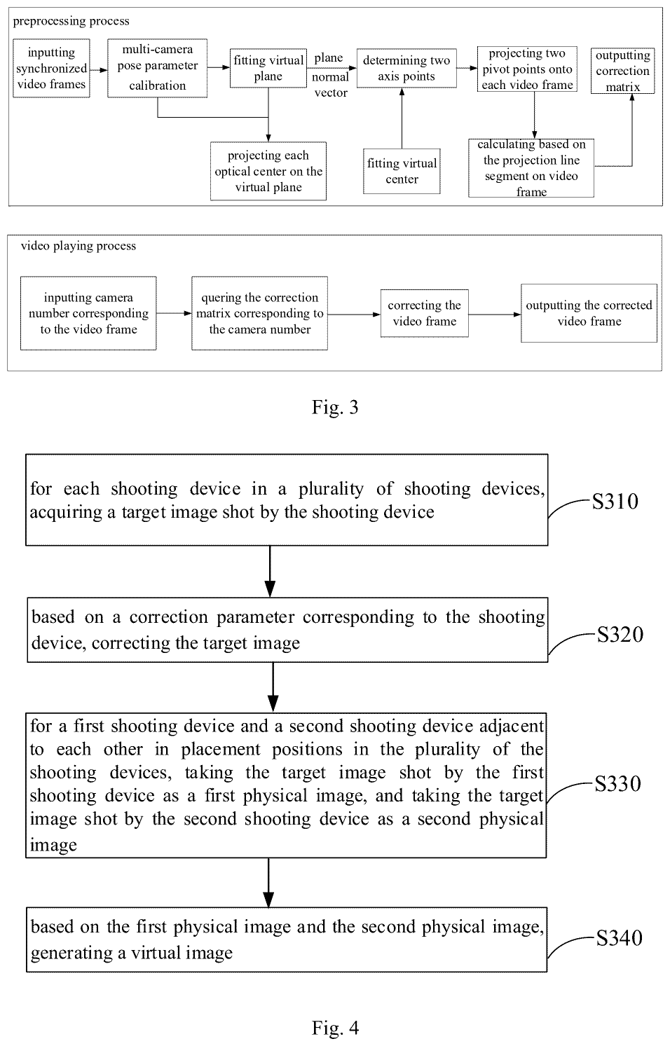

In order to better understand the above embodiments as a whole, they are exemplarily described below in combination with examples. Exemplarily, both the target image and the sample image are video frames in a video shot by the shooting device, the process of determining the correction matrix may be understood as a preprocessing process, and the application process of the correction matrix may occur in a video playing process. On this basis, referring to FIG. 3, synchronized video frames (that is, the synchronized sample images) are input, and multi-camera self-calibration is performed based on these video frames, to obtain the pose parameter of each camera. According to the optical center coordinate of the physical optical center of each camera, it is fitted to obtain the virtual plane, and in combination with the pose parameter, each physical optical center is projected onto the virtual plane, and each projection result is fitted, to obtain the virtual center. The plane normal vector of the virtual plane is calculated, and the plane normal vector passing through the virtual center is taken as the rotation axis, to determine two axis points in the rotation axis. These two pivot points are projected onto each video frame, to obtain a projection line segment on each video frame. An affine transformation matrix (that is, the correction matrix) of the corresponding camera is calculated based on the projection line segment on each video frame, the correction matrix is output, and the correction matrix corresponds to the camera number of the corresponding camera one by one. At this time, the preprocessing process is completed. In the video playing process, for a certain video frame (that is, the target image) acquired, the camera number corresponding to the video frame is input, the correction matrix corresponding to the camera number is queried, then the video frame is corrected based on the correction matrix, and finally, the corrected video frame is output, thereby achieving the offline storage or real-time playing based on the corrected video frame.

Before the following embodiments of the present disclosure are introduced, their application scenes are exemplarily described firstly: free perspective shooting is taken as an example, in order to shoot a multi-perspective video in the free perspective, a collection end often needs to set up the plurality of the shooting devices to synchronously collect videos, so that a smooth spatial video viewing experience is constructed at a playing end. However, the set up scheme for the plurality of the shooting devices has the following conditions: 1) the hardware cost is relatively high; 2) the shooting device needs to achieve consistency in device parameters such as white balance and brightness, as well as consistency in time synchronization, the greater the number of shooting devices, the more difficult to achieve the consistency; and 3) it is necessary to calibrate the pose parameter of each shooting device, the greater the number of shooting devices may cause a significant increase in calibration complexity, and then cause the calibration time too long. It should be noted that, the following embodiments are described by taking an application scene shot in the free perspective as an example, but this does not mean that the following embodiments may only be applied in this application scene, and the image correction process in other application scenes (such as an application scene of optical field shooting) is still applicable.

FIG. 4 is a flow diagram of another image correction method provided in an embodiment of the present disclosure. This embodiment is adjusted based on the above embodiments. In this embodiment, for example, after the target image is corrected, the above image correction method may further include: for a first shooting device and a second shooting device adjacent to each other in placement positions in the plurality of the shooting devices, taking the target image shot by the first shooting device as a first physical image, and taking the target image shot by the second shooting device as a second physical image; and based on the first physical image and the second physical image, generating a virtual image, herein a virtual perspective in which the virtual image is located is located between a physical perspective in which the first physical image is located and a physical perspective in which the second physical image is located. The explanation of terms that are the same or correspond to the above embodiments is not repeatedly described here.

Correspondingly, as shown in FIG. 4, the method in this embodiment may include the following steps:
S310, for each shooting device in a plurality of shooting devices, acquiring a target image shot by the shooting device.
S320, based on a correction parameter corresponding to the shooting device, correcting the target image, in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to a physical optical center of the plurality of the shooting devices.
S330, for a first shooting device and a second shooting device adjacent to each other in placement positions in the plurality of the shooting devices, taking the target image shot by the first shooting device as a first physical image, and taking the target image shot by the second shooting device as a second physical image.

The first shooting device and the second shooting device may be two adjacent shooting devices in the placement positions, because they are actual electronic devices, the target images shot by them may be referred to as physical images. Here, the target image shot by the first shooting device is taken as the first physical image, and the target image shot by the second shooting device is taken as the second physical image.
S340, based on the first physical image and the second physical image, generating a virtual image, a virtual perspective in which the virtual image is located is located between a physical perspective in which the first physical image is located and a physical perspective in which the second physical image is located.

The virtual image is generated based on the first physical image and the second physical image, and the virtual perspective in which the virtual image is located is located between the physical perspective in which the first physical image is located and the physical perspective in which the second physical image is located, that is, the virtual image in the virtual perspective between the adjacent physical perspectives is automatically synthesized to achieve the effect of video frame insertion. In this way, in order to achieve the same spatial video viewing experience, or equivalent or better free perspective video effect, the number of the shooting devices may be reduced by generating the virtual image (that is, the image in the virtual perspective), thereby avoiding a series of conditions caused by too many shooting devices, which is a lightweight free perspective collection scheme.

In the embodiments of the present disclosure, for the first physical image shot by the first shooting device and the second physical image shot by the second shooting device which is adjacent to the first shooting device in the placement position in the plurality of the shooting devices, the virtual image in the virtual perspective between the corresponding physical perspectives is generated according to the two, and the number of the shooting devices is reduced by generating the virtual image, therefore, the conditions of relatively high hardware cost, difficulty in consistency, and long calibration time caused by too many shooting devices are avoided.

In an embodiment, based on the above embodiments, the step of, based on the first physical image and the second physical image, generating the virtual image, may include: determining a first depth-of-field of the first shooting device and a second depth-of-field of the second shooting device, matching the first physical image and the second physical image, performing point cloud reconstruction according to the first depth-of-field, the second depth-of-field, and a matching result, and acquiring the virtual image based on a point cloud reconstruction result. The matching process of the first physical image and the second physical image may be achieved based on algorithms such as stereo matching and the like, and then the point cloud reconstruction is performed based on the first depth-of-field, the second depth-of-field, and the matching result, thereby generating a point cloud in the virtual perspective to obtain the virtual image, thus the effect of video frame insertion is achieved.

In another embodiment, based on the above embodiments, the step of, based on the first physical image and the second physical image, generating the virtual image, may include: calculating an optical flow by taking the first physical image and the second physical image as a video file, and generating the virtual image according to the optical flow. The free perspective is a result of multi-perspective shooting in space at the same time point, in other words, it may also be understood as a shooting result based on the same shooting device at a plurality of spatial positions (that is, a plurality of perspectives), which is a time domain. Therefore, the first physical image and the second physical image may be taken as the video file to calculate the optical flow, and then the virtual image is generated according to the optical flow, thus the effect of video frame insertion is achieved.

In another embodiment, based on the above embodiment, the step of, based on the first physical image and the second physical image, generating the virtual image, may include: inputting the first physical image and the second physical image into a pre-trained video insert frame deep-learning model, and according to an output result of the video insert frame deep-learning model, generating the virtual image. The video insert frame deep-learning model may be understood as an end-to-end deep-learning model configured for achieving video frame insertion, and after the first physical image and the second physical image are input into the video insert frame deep-learning model, the virtual image in the virtual perspective between the two physical perspectives may be acquired, for example, two virtual images may be generated based on the two physical images, thereby achieving the effect of video frame insertion.

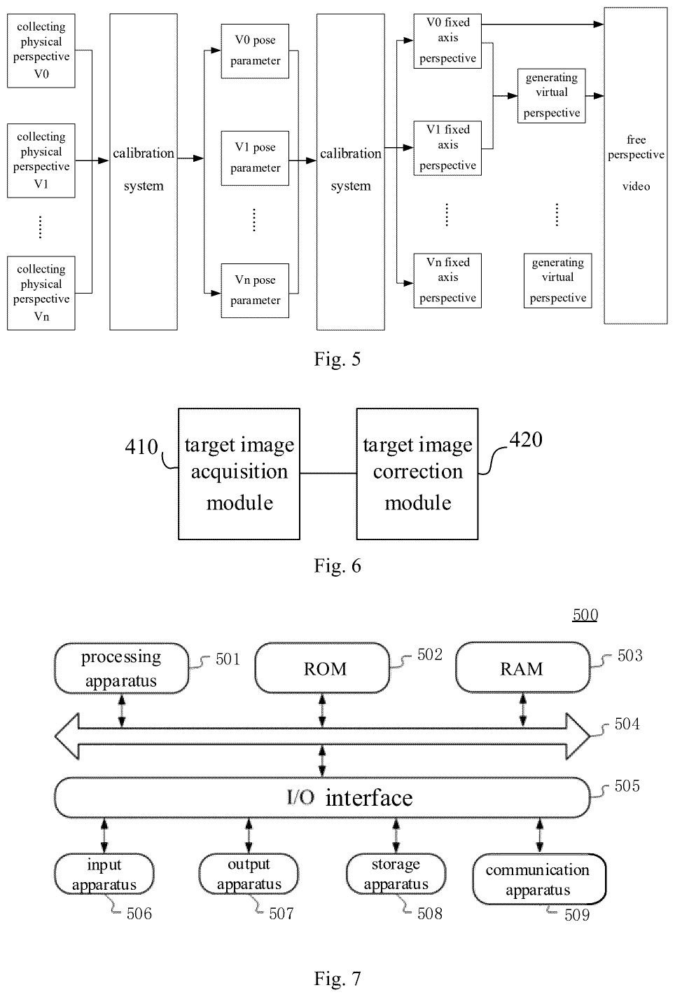

In order to better understand the above embodiments as a whole, they are exemplarily described below in combination with examples. Exemplarily, by deploying cameras around in a plurality of physical perspectives in sites such as a stage, a stadium, or a studio, a multi-channel video collected in the site (that is, the collection end) is transmitted back to a video cloud for processing by a network, then the processed free perspective video is transmitted in real time to the playing end for playing, so that the user's viewing experience is more immersive. On the video cloud, the collected multi-channel video may be processed as shown in FIG. 5: the collected multi-channel video is input into a calibration system, to obtain the pose parameter of each camera; then, the multi-channel video and the corresponding pose parameter are input into a fixed axis system to convert spatial points of each video to a fixed axis coordinate system, and the corresponding fixed axis perspective (that is, the physical perspective under the fixed axis) is acquired; and then, the virtual perspective is generated based on adjacent fixed axis perspectives, thereby acquiring the free perspective video based on the fixed axis perspective and the virtual perspective. This is a lightweight free perspective collection scheme.

FIG. 6 is a structure block diagram of an image correction apparatus provided in an embodiment of the present disclosure, and the apparatus is configured to execute the image correction method provided in any of the above embodiments. The apparatus and the image correction method in the above embodiments belong to the same concept, and the detailed content that is not described in detail in embodiments of the image correction apparatus may refer to the embodiments of the above image correction method. Referring to FIG. 6, the apparatus may specifically include: a target image acquisition module 410 and a target image correction module 420.

The target image acquisition module 410 is configured to, for each shooting device in a plurality of shooting devices, acquire a target image shot by the shooting device.

The target image correction module 420 is configured to, based on a correction parameter corresponding to the shooting device, correct the target image.

In the case that at least two axis points in a rotation axis containing a virtual center are projected onto the target image to obtain a projection axis, projection axes on corrected target image are consistent, and the virtual center is located on a virtual plane corresponding to the plurality of the shooting devices, and corresponds to a physical optical center of the plurality of the shooting devices.

In one embodiment, the correction parameter is predetermined by the following modules:
a virtual center acquisition module, configured to determine the virtual plane, and acquire the virtual center on the virtual plane;
a sample axis acquisition module, configured to determine the rotation axis containing the virtual center, and project the at least two axis points in the rotation axis onto a sample image shot respectively by each shooting device, to obtain a sample axis.
an auxiliary sample image acquisition module, configured to, in sample images, take the sample image shot by a main shooting device in the plurality of the shooting devices as a main sample image, and take the sample image shot by an auxiliary shooting device as an auxiliary sample image;
an auxiliary sample image correction module, configured to, for each auxiliary sample image, correct the auxiliary sample image, so that the sample axis on a corrected auxiliary sample image is consistent with the sample axis on the main sample image; and
a first correction parameter acquisition module, configured to acquire the correction parameter of each shooting device according to a correction result.

On this basis, in one example, the above image correction apparatus may further include:
a pose parameter acquisition module, configured to determine a pose parameter of each shooting device respectively.

The virtual center acquisition module may include:
a virtual plane acquisition unit, configured to fit to obtain a plane equation according to an optical center position of each optical center, and acquire the virtual plane based on the plane equation; and
a virtual center acquisition unit, configured to, for each shooting device, according to the plane equation and the pose parameter of the shooting device, project an optical center position corresponding to the shooting device onto the virtual plane, to obtain a projection position, after acquiring each projection position, fit each projection position to obtain a virtual position, and acquire the virtual center based on the virtual position.

On this basis, in one example, the sample axis acquisition module may include:
an axis point projection unit, configured to, for each shooting device, based on the pose parameter of the shooting device, project at least two axis points in the rotation axis onto the sample image shot by the shooting device.

On this basis, in one example, the pose parameter acquisition module may include:
a feature matching relationship determination unit, configured to acquire a sample image sequence shot by each shooting device respectively, and determine a feature matching relationship between sample image sequences; and
a pose parameter acquisition unit, configured to acquire the pose parameter of each shooting device respectively according to the feature matching relationship.

In another example, the sample axis acquisition module may include:
a plane normal vector acquisition unit, configured to acquire a plane equation of the virtual plane, and normalize the plane equation, to obtain a plane normal vector of the virtual plane; and
a rotation axis acquisition unit, configured to take an axis in which the plane normal vector containing the virtual center is located as the rotation axis.

In another example, the sample axis is represented by a sample line segment, and the auxiliary sample image correction module may include:
an auxiliary sample image correction unit, configured to perform a correction operation on the auxiliary sample image, so that the sample line segment on the corrected auxiliary sample image and the sample line segment on the main sample image are parallel to each other and with a same length, and a relative position of the sample line segment on the corrected auxiliary sample image is the same as the relative position of the sample line segment on the main sample image, the correction operation includes a rotation operation, a scaling operation, and a translation operation.

In another example, the above image correction apparatus may further include:
a main sample image rotation module, configured to, before correcting the auxiliary sample image, rotate the main sample image, so that the sample axis on a rotated main sample image is parallel to a target axis of the main sample image.
a second correction parameter acquisition module, configured to update the main sample image according to a rotation result, and acquire the correction parameter of the main shooting device; and
a first correction parameter acquisition module, configured to acquire the correction parameter of the auxiliary shooting device according to the correction result.

In another example, the above image correction apparatus, may further include:
a second physical image acquisition module, configured to, after correcting the target image, for a first shooting device and a second shooting device adjacent to each other in placement positions in the plurality of the shooting devices, take the target image shot by the first shooting device as a first physical image, and take the target image shot by the second shooting device as a second physical image; and
a virtual image generation module, configured to, based on the first physical image and the second physical image, generate a virtual image, a virtual perspective in which the virtual image is located is located between a physical perspective in which the first physical image is located and a physical perspective in which the second physical image is located.

On this basis, in another example, the virtual image generation module may include:
a first virtual image generation unit, configured to determine a first depth-of-field of the first shooting device and a second depth-of-field of the second shooting device, match the first physical image and the second physical image, perform point cloud reconstruction according to the first depth-of-field, the second depth-of-field, and a matching result, and acquire the virtual image based on a point cloud reconstruction result.

In another example, the virtual image generation module may include:
a second virtual image generation unit, configured to calculate optical flow by taking the first physical image and the second physical image as a video file, and generate the virtual image according to the optical flow.

In another example, the virtual image generation module may include:
a third virtual image generation unit, configured to input the first physical image and the second physical image into a pre-trained video insert frame deep-learning model, and according to an output result of the video insert frame deep-learning model, generate the virtual image.

The image correction apparatus provided in the embodiment of the present disclosure, in combination with the target image acquisition module and the target image correction module, for each shooting device in the plurality of the shooting devices, corrects the target image shot by the shooting device by the correction parameter corresponding to the shooting device. The above apparatus, for the virtual center corresponding to the physical optical centers of the plurality of the shooting devices on the virtual plane corresponding to the plurality of the shooting devices, projects at least two axis points in the rotation axis containing the virtual center onto the target image to obtain the projection axis, and the projection axes on corrected target images are consistent, which indicates that the corrected target images correspond to the same rotation axis, that is, the spatial points on them are all converted from the respective shooting device coordinate systems to the fixed axis coordinate system. Therefore, the corrected target images no longer have the jittering phenomenon due to the change of the perspectives, thereby eliminating the image jittering phenomenon caused by the change of the adjacent perspectives, in addition, because the synchronized image correction may be performed during the normal shooting processes, the requirements for the accuracy of setting up the plurality of the shooting devices are reduced.

The image correction apparatus provided in the embodiments of the present disclosure may execute the image correction method provided in any embodiments of the present disclosure, and has corresponding functional modules and beneficial effects for executing the method.

It is worth noting that in the embodiments of the above image correction apparatus, the various units and modules included are only divided according to functional logic, but are not limited to the above division, as long as the corresponding functions can be implemented; in addition, the specific name of each functional unit is only for the purpose of distinguishing mutually, and is not intended to limit the protection scope of the present disclosure.

Referring to FIG. 7 below, it shows a structure schematic diagram of an electronic device (such as a terminal device or a server in FIG. 7) 500 suitable for implementing the embodiments of the present disclosure. The electronic device in the embodiment of the present disclosure may include but not limited to a mobile terminal such as a mobile phone, a notebook computer, a digital radio broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device shown in FIG. 7 is only an example and should not impose any limitations on the functions and usage scopes of the embodiments of the present disclosure.

As shown in FIG. 7, the electronic device 500 may include a processing apparatus (such as a central processing unit, a graphics processor, and the like) 501, which may execute various appropriate actions and processes according to a program stored in a read-only memory (ROM) 502 or a program loaded from a storage apparatus 508 to a random access memory (RAM) 503. In the RAM 503, various programs and data required for operations of the electronic device 500 are further stored. The processing apparatus 501, ROM 502, and RAM 503 are connected to each other by a bus 504. An input/output (I/O) interface 505 is also connected to the bus 504.

Generally, the following apparatuses may be connected to the I/O interface 505: an input apparatus 506 such as a touch screen, a touchpad, a keyboard, a mouse, a camera, a microphone, an accelerometer, a gyroscope and the like; an output apparatus 507 such as a liquid crystal display (LCD), a loudspeaker, a vibrator and the like; a storage apparatus 508 such as a magnetic tape, a hard disk drive and the like; and a communication apparatus 509. The communication apparatus 509 may allow the electronic device 500 to wireless-communicate or wire-communicate with other devices, so as to exchange data. Although FIG. 7 shows the electronic device 500 with various apparatuses, it should be understood that it is not required to implement or possess all the apparatuses shown. It may implement alternatively or possess the more or less apparatuses.

Specifically, according to the embodiment of the present disclosure, the process described above with reference to the flow diagram may be achieved as a computer software program. For example, an embodiment of the present disclosure includes a computer program product, which includes a computer program loaded on a non-transient computer-readable medium, and the computer program contains program codes for executing the method shown in the flow diagram. In such an embodiment, the computer program may be downloaded and installed from the network by the communication apparatus 509, or installed from the storage apparatus 508, or installed from ROM 502. When the computer program is executed by the processing apparatus 501, the above functions limited in the method in the embodiments of the present disclosure are executed.

It should be noted that the computer-readable medium mentioned above in the present disclosure may be a computer-readable signal medium, a computer-readable storage medium, or any combinations of the two. The computer-readable storage medium may be but not limited to, for example, a system, an apparatus or a device of electricity, magnetism, light, electromagnetism, infrared, or semiconductor, or any combinations of the above. More specific examples of the computer-readable storage medium may include but not limited to: an electric connector with one or more wires, a portable computer magnetic disk, a hard disk drive, a random-access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, which carries the computer-readable program codes. The data signal propagated in this way may adopt various forms, including but not limited to an electromagnetic signal, an optical signal, or any suitable combinations of the above. The computer-readable signal medium may further be any computer-readable medium other than the computer-readable storage medium, and the computer-readable signal medium may send, propagate, or transmit the program used by or in combination with the instruction executive system, apparatus or device. The program code contained on the computer-readable medium may be transmitted by using any suitable medium, including but not limited to: an electric wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an Internet work (such as the Internet), and an end-to-end network (such as an ad hoc end-to-end network), as well as any currently known or future-developed networks.

The above computer-readable medium may be contained in the above electronic device; and it may also exist separately without being assembled into the electronic device.

The above computer-readable medium carries one or more programs, and when the above one or more programs are executed by the electronic device, the electronic device:
for each shooting device in a plurality of shooting devices, acquires a target image shot by the shooting device; and
based on a correction parameter corresponding to the shooting device, corrects the target image;
in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to a physical optical center of the plurality of the shooting devices.

The storage medium may be non-transitory storage medium.

Computer program codes for performing the operations of the present disclosure may be written in one or more programming languages or a combination thereof, the programming languages include, but are not limited to, object-oriented programming languages such as Java, Smalltalk and C++, and further include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server. In the case of involving the remote computer, the remote computer may be connected to the user's computer through any type of network, including a local area network (LAN) or a wide area network (WAN), or may be connected to an external computer (for example, through the Internet using an Internet service provider).

The flow diagrams and the block diagrams illustrate the architecture, function and operation of possible implementations of the systems, methods and the computer program product according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions noted in the blocks may occur out of the order noted in the accompanying drawings. For example, two blocks illustrated in succession may, in fact, be executed substantially in parallel, and may sometimes be executed in a reverse order, depending on the function involved. It should also be noted that, each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The involved units described in the embodiments of the present disclosure may be achieved by a mode of software, or may be achieved by a mode of hardware. The name of the unit does not constitute a limitation on the unit itself in a certain situation. For example, the target image acquisition module may also be described as “a module used for acquiring a target image shot by the shooting device for each shooting device in a plurality of shooting devices”.

The functions described above in this article may be at least partially executed by one or more hardware logic components. For example, non-restrictively, exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination of the above.

According to one or more embodiments of the present disclosure, [Example 1] provides an image correction method, which may include:
for each shooting device in a plurality of shooting devices, acquiring a target image shot by the shooting device; and
based on a correction parameter corresponding to the shooting device, correcting the target image;
wherein in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

According to one or more embodiments of the present disclosure, [Example 2] provides the method of example 1, the correction parameter is predetermined by the following steps:
determining the virtual plane, and acquiring the virtual center on the virtual plane;
determining the rotation axis containing the virtual center, and projecting the at least two axis points in the rotation axis onto a sample image shot respectively by each shooting device, to obtain a sample axis;
in sample images, taking the sample image shot by a main shooting device in the plurality of the shooting devices as a main sample image, and taking the sample image shot by an auxiliary shooting device as an auxiliary sample image;
for each auxiliary sample image, correcting the auxiliary sample image, so that the sample axis on a corrected auxiliary sample image is consistent with the sample axis on the main sample image; and acquiring the correction parameter of each shooting device according to a correction result.

According to one or more embodiments of the present disclosure, [Example 3] provides the method of example 2, the image correction method mentioned above may further include:
determining a pose parameter of each shooting device respectively;
the determining the virtual plane, and acquiring the virtual center on the virtual plane, including:
fitting to obtain a plane equation according to the optical center position of each optical center, and acquiring the virtual plane based on the plane equation; and
for each shooting device, according to the plane equation and the pose parameter of the shooting device, projecting an optical center position corresponding to the shooting device onto the virtual plane, to obtain a projection position, after acquiring each projection position, fitting each projection position to obtain a virtual position, and acquiring the virtual center based on the virtual position.

According to one or more embodiments of the present disclosure, [Example 4] provides the method of example 3, the determining a pose parameter of each shooting device respectively, may include:
acquiring a sample image sequence shot by each shooting device respectively, and determining a feature matching relationship between the sample image sequences; and
acquiring the pose parameter of each shooting device respectively according to the feature matching relationship.

According to one or more embodiments of the present disclosure, [Example 5] provides the method of example 2, the determining the rotation axis containing the virtual center, may include:
acquiring a plane equation of the virtual plane, and normalizing the plane equation, to obtain a plane normal vector of the virtual plane; and
taking an axis in which, the plane normal vector containing the virtual center is located as the rotation axis.

According to one or more embodiments of the present disclosure, [Example 6] provides the method of example 2, the sample axis is represented by a sample line segment, and the correcting the auxiliary sample image, so that a sample axis on a corrected auxiliary sample image is consistent with the sample axis on the main sample image, may include:
performing a correction operation on the auxiliary sample image, so that the sample line segment on the corrected auxiliary sample image and the sample line segment on the main sample image are parallel to each other and with a same length, and a relative position of the sample line segment on the corrected auxiliary sample image is the same as the relative position of the sample line segment on the main sample image, wherein the correction operation includes a rotation operation, a scaling operation, and a translation operation.

According to one or more embodiments of the present disclosure, [Example 7] provides the method of example 2, before the correcting the auxiliary sample image, the image correcting method mentioned above, may further include:
rotating the main sample image, so that the sample axis on a rotated main sample image is parallel to a target axis of the sample image;
updating the main sample image according to a rotation result, and acquiring the correction parameter of the main shooting device; and
the acquiring the correction parameter of each shooting device according to a correction result, may including:
acquiring the correction parameter of the auxiliary shooting device according to the correction result.

According to one or more embodiments of the present disclosure, [Example 8] provides the method of example 1, after correcting the target image, the image correcting method mentioned above, may further include:
for a first shooting device and a second shooting device adjacent to each other in placement positions in the plurality of the shooting devices, taking the target image shot by the first shooting device as a first physical image, and taking the target image shot by the second shooting device as a second physical image; and
based on the first physical image and the second physical image, generating a virtual image, wherein a virtual perspective in which the virtual image is located is located between a physical perspective in which the first physical image is located and a physical perspective in which the second physical image is located.

According to one or more embodiments of the present disclosure, [Example 9] provides the method of example 8, the based on the first physical image and the second physical image, generating a virtual image, may further include:
determining a first depth-of-field of the first shooting device and a second depth-of-field of the second shooting device, matching the first physical image and the second physical image, performing point cloud reconstruction according to the first depth-of-field, the second depth-of-field, and a matching result, and acquiring the virtual image based on a point cloud reconstruction result.

According to one or more embodiments of the present disclosure, [Example 10] provides the method of example 8, the based on the first physical image and the second physical image, generating the virtual image, may further include:
calculating optical flow by taking the first physical image and the second physical image as a video file, and generating the virtual image according to the optical flow.

According to one or more embodiments of the present disclosure, [Example 11] provides the method of example 8, the based on the first physical image and the second physical image, generating a virtual image, may further include:
inputting the first physical image and the second physical image into a pre-trained video insert frame deep-learning model, and according to an output result of the video insert frame deep-learning model, generating the virtual image.

According to one or more embodiments of the present disclosure, [Example 12] provides an image correction apparatus, which may include:
a target image acquisition module, configured to, for each shooting device in a plurality of shooting devices, acquire a target image shot by the shooting device; and
a target image correction module, configured to, based on a correction parameter corresponding to the shooting device, correct the target image;
in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

It will be appreciated by those skilled in the art that the scope of the disclosure involved herein is not limited to the embodiments formed by a specific combination of the technical features described above, and shall cover other embodiments formed by any combination of the technical features described above or equivalent features thereof without departing from the concept of the present disclosure. For example, the technical features described above may be mutually replaced with the technical features having similar functions disclosed herein (but not limited thereto) to form new embodiments.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An image correction method, comprising:
for each shooting device in a plurality of shooting devices, acquiring a target image shot by the shooting device; and
based on a correction parameter corresponding to the shooting device, correcting the target image;
wherein in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

2. The method according to claim 1, wherein the correction parameter is predetermined by the following steps:
determining the virtual plane, and acquiring the virtual center on the virtual plane;
determining the rotation axis containing the virtual center, and projecting the at least two axis points in the rotation axis onto a sample image shot respectively by the each shooting device, to obtain a sample axis;
in sample images, taking the sample image shot by a main shooting device in the plurality of the shooting devices as a main sample image, and taking the sample image shot by an auxiliary shooting device as an auxiliary sample image;
for each auxiliary sample image, correcting the auxiliary sample image, so that the sample axis on a corrected auxiliary sample image is consistent with the sample axis on the main sample image; and
acquiring correction parameters of the plurality of shooting devices according to a correction result.

3. The method according to claim 2, further comprising:
determining a pose parameter of the each shooting device respectively;
the determining the virtual plane, and acquiring the virtual center on the virtual plane, comprising:
fitting to obtain a plane equation according to optical center positions of optical centers of the plurality of the shooting devices, and acquiring the virtual plane based on the plane equation; and
for the each shooting device, according to the plane equation and the pose parameter of the shooting device, projecting an optical center position corresponding to the shooting device onto the virtual plane, to obtain a projection position, after acquiring each projection position, fitting each projection position to obtain a virtual position, and acquiring the virtual center based on the virtual position.

4. The method according to claim 3, wherein the determining the pose parameter of the each shooting device respectively, comprising:
acquiring a sample image sequence shot by each shooting device respectively, and determining a feature matching relationship between sample image sequences; and
acquiring the pose parameter of the each shooting device respectively according to the feature matching relationship.

5. The method according to claim 2, wherein the determining the rotation axis containing the virtual center, comprising:
acquiring a plane equation of the virtual plane, and normalizing the plane equation, to obtain a plane normal vector of the virtual plane; and
taking an axis in which the plane normal vector containing the virtual center is located as the rotation axis.

6. The method according to claim 2, wherein the sample axis is represented by a sample line segment, and the correcting the auxiliary sample image, so that the sample axis on the corrected auxiliary sample image is consistent with the sample axis on the main sample image, comprising:
performing a correction operation on the auxiliary sample image, so that the sample line segment on the corrected auxiliary sample image and the sample line segment on the main sample image are parallel to each other and with a same length, and a relative position of the sample line segment on the corrected auxiliary sample image is the same as the relative position of the sample line segment on the main sample image, wherein the correction operation comprises a rotation operation, a scaling operation, and a translation operation.

7. The method according to claim 2, wherein before the correcting the auxiliary sample image, further comprising:
rotating the main sample image, so that the sample axis on a rotated main sample image is parallel to a target axis of the main sample image;
updating the main sample image according to a rotation result, and acquiring the correction parameter of the main shooting device; and
the acquiring correction parameters of the plurality of shooting devices according to the correction result, comprising:
acquiring the correction parameter of the auxiliary shooting device according to the correction result.

8. The method according to claim 1, wherein after the correcting the target image, further comprising:
for a first shooting device and a second shooting device adjacent to each other in placement positions in the plurality of the shooting devices, taking the target image shot by the first shooting device as a first physical image, and taking the target image shot by the second shooting device as a second physical image; and
based on the first physical image and the second physical image, generating a virtual image, wherein a virtual perspective in which the virtual image is located is located between a physical perspective in which the first physical image is located and a physical perspective in which the second physical image is located.

9. The method according to claim 8, wherein the based on the first physical image and the second physical image, generating the virtual image, comprising:
determining a first depth-of-field of the first shooting device and a second depth-of-field of the second shooting device, matching the first physical image and the second physical image, performing point cloud reconstruction according to the first depth-of-field, the second depth-of-field, and a matching result, and acquiring the virtual image based on a point cloud reconstruction result.

10. The method according to claim 8, wherein the based on the first physical image and the second physical image, generating the virtual image, comprising:
calculating optical flow by taking the first physical image and the second physical image as a video file, and generating the virtual image according to the optical flow.

11. The method according to claim 8, wherein the based on the first physical image and the second physical image, generating the virtual image, comprising:
inputting the first physical image and the second physical image into a pre-trained video insert frame deep-learning model, and according to an output result of the video insert frame deep-learning model, generating the virtual image.

12. (canceled)

13. An electronic device, comprising:
one or more processors; and
a memory, configured to store one or more programs;
in the case that the one or more programs are executed by the one or more processors, the one or more processors implements:
for each shooting device in a plurality of shooting devices, acquiring a target image shot by the shooting device; and
based on a correction parameter corresponding to the shooting device, correcting the target image;
wherein in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

14. A computer-readable storage medium, wherein the computer-readable storage medium stores a computer program, in the case that the computer program is executed by a processor, the computer program implements:
for each shooting device in a plurality of shooting devices, acquiring a target image shot by the shooting device; and
based on a correction parameter corresponding to the shooting device, correcting the target image;
wherein in the case that at least two axis points in a rotation axis containing a virtual center are projected onto the target image to obtain a projection axis, projection axes on corrected target images are consistent, and the virtual center is located on a virtual plane corresponding to the plurality of the shooting devices, and corresponds to physical optical centers of the plurality of the shooting devices.

15. The electronic device according to claim 13, wherein in the case that the one or more programs are executed by the one or more processors, the one or more processors further implements:
determining the virtual plane, and acquiring the virtual center on the virtual plane;
determining the rotation axis containing the virtual center, and projecting the at least two axis points in the rotation axis onto a sample image shot respectively by the each shooting device, to obtain a sample axis;
in sample images, taking the sample image shot by a main shooting device in the plurality of the shooting devices as a main sample image, and taking the sample image shot by an auxiliary shooting device as an auxiliary sample image;
for each auxiliary sample image, correcting the auxiliary sample image, so that the sample axis on a corrected auxiliary sample image is consistent with the sample axis on the main sample image; and
acquiring correction parameters of the plurality of shooting devices according to a correction result.

16. The electronic device according to claim 15, wherein in the case that the one or more programs are executed by the one or more processors, the one or more processors further implements:
determining a pose parameter of the each shooting device respectively;
the determining the virtual plane, and acquiring the virtual center on the virtual plane, comprising:
fitting to obtain a plane equation according to optical center positions of optical centers of the plurality of the shooting devices, and acquiring the virtual plane based on the plane equation; and
for the each shooting device, according to the plane equation and the pose parameter of the shooting device, projecting an optical center position corresponding to the shooting device onto the virtual plane, to obtain a projection position, after acquiring each projection position, fitting each projection position to obtain a virtual position, and acquiring the virtual center based on the virtual position.

17. The electronic device according to claim 16, wherein in the case that the one or more programs are executed by the one or more processors, the one or more processors further implements:
acquiring a sample image sequence shot by each shooting device respectively, and determining a feature matching relationship between sample image sequences; and
acquiring the pose parameter of the each shooting device respectively according to the feature matching relationship.

18. The electronic device according to claim 15, wherein in the case that the one or more programs are executed by the one or more processors, the one or more processors further implements:
acquiring a plane equation of the virtual plane, and normalizing the plane equation, to obtain a plane normal vector of the virtual plane; and
taking an axis in which the plane normal vector containing the virtual center is located as the rotation axis.

19. The electronic device according to claim 15, wherein in the case that the one or more programs are executed by the one or more processors, the one or more processors further implements:
performing a correction operation on the auxiliary sample image, so that a sample line segment on the corrected auxiliary sample image and the sample line segment on the main sample image are parallel to each other and with a same length, and a relative position of the sample line segment on the corrected auxiliary sample image is the same as the relative position of the sample line segment on the main sample image, wherein the correction operation comprises a rotation operation, a scaling operation, and a translation operation.

20. The electronic device according to claim 15, wherein in the case that the one or more programs are executed by the one or more processors, the one or more processors further implements:
rotating the main sample image, so that the sample axis on a rotated main sample image is parallel to a target axis of the main sample image;
updating the main sample image according to a rotation result, and acquiring the correction parameter of the main shooting device; and
the acquiring correction parameters of the plurality of shooting devices according to the correction result, comprising:
acquiring the correction parameter of the auxiliary shooting device according to the correction result.

21. The electronic device according to claim 13, wherein in the case that the one or more programs are executed by the one or more processors, the one or more processors further implements:
for a first shooting device and a second shooting device adjacent to each other in placement positions in the plurality of the shooting devices, taking the target image shot by the first shooting device as a first physical image, and taking the target image shot by the second shooting device as a second physical image; and
based on the first physical image and the second physical image, generating a virtual image, wherein a virtual perspective in which the virtual image is located is located between a physical perspective in which the first physical image is located and a physical perspective in which the second physical image is located.
